(19) United States
(12) Patent Application Publication
(10) Pub. No.: US 2026/0310180 A1
(43) Pub. Date: Oct. 8, 2026

(54) METHOD FOR PROVIDING INTERACTIVE CO-PILOT IN AN INDUSTRIAL OPERATION AND A SYSTEM THEREOF

(71) Applicant: Honeywell International Inc., Charlotte, NC (US)

(72) Inventors: Abhishek Pednekar, West Hills, CA (US); Jeffrey Renfro, Deer Park, TX (US); John Goodman, Katy, TX (US); Vijayamahantesh Karpurmath, Bangalore (IN); Palavesh Kalyana Sundaram, Bangalore (IN)

(21) Appl. No.: 19/171,391

(22) Filed: Apr. 7, 2025

(51) Int. Cl. G05B 19/418

(52) U.S. Cl. CPC G05B 19/4184; G05B 19/41885

(57) ABSTRACT

A method for providing interactive co-pilot in an industrial operation, comprising providing an interactive user interface (UI), wherein the user interface provides natural language processing capability for processing one or more user requests. Based on user requests, the method comprises accessing a real-time digital twin of one or more processes and associated assets with the one or more processes, wherein the real-time digital twin includes an asset digital twin and a process digital twin, receiving the one or more user requests including at least one of execution of optimization scenarios, monitoring anomaly, and unplanned event detection. Further, the method comprises monitoring one or more asset parameters associated with assets and processes from the asset digital twin and process digital twin, simulating, by a machine learning (ML) model, one or more scenarios corresponding to the user request to generate one or more outcomes, based on the one or more asset parameters and the one or more process parameters and presenting to a user, via the interactive user interface, the one or more outcomes corresponding to the user request for user selection.

### TECHNICAL FIELD

Present disclosure generally relates to providing user interface for an industrial operation. More particularly, the present disclosure relates to a method and a system for providing an interactive co-pilot coupled to a digital twin of an industrial operation for providing aid to operators in accessing and controlling the industrial operations.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In an industrial process, typically, there are numerous processes and each process may involve one or more assets which performs the process. Each asset in the process has a particular function variable/standard operating procedure and in many situations, there could be anomalies in function variables. The workforce, which involves skilled technicians, asset operators, and performance monitoring technicians, regularly monitors the functioning of the different assets and its functional variables and are responsible for the smooth functioning of processes in the industry.

In a typical industrial operation, multiple processes are operated and multiple assets are involved with running of the processes. In many instances, there may be downtimes due to potential issues with any process or any asset associated with a process. Generally, the operators of the industrial operations become aware of the glitches or anomaly after they have occurred and, subsequently, the operators along with subject matter experts find a solution to mitigate the anomaly, which is usually time-consuming process. As a continuing development in this area of mitigation of anomalies, sophisticated systems have evolved which may provide early event prediction based on which the operators/engineers may validate a root cause for the anomaly and find a mitigation strategy to avoid unplanned downtime.

There are numerous challenges like handling of equipment failure, production issues, functional issues, knowing how, technical support, time management, etc. In a plant facility, there are workforce including experts, equipment operators, and maintenance engineers who are involved in running and executing the asset or equipment on a day-to-day basis. However, any failure in the asset/equipment, or underlying products needs to be resolved in a quick turn-around time to have minimum impact on the overall functioning of the facility.

Whenever there is an issue with equipment/devices/products/assets, the workforce at the facilities has to rely on their competency and approach the in-house expertise/support team to get resolutions/propositions with interim approaches. However, such measures may take a longer time resolution of the issues and often affect the overall functioning of the equipment/plant.

Also, there can be situations, where the process variables and standard operating procedures of an equipment may vary from industry to industry. Therefore, a resolution which works in one industry with respect to the equipment may not be appropriate in another industry. A skilled person in a new industrial environment may not be able to find a quick resolution to the identified problem with the equipment, as the equipment in the first industry and the second industry may be functioning in different operating conditions.

Digital twins are generally known in the state of the art for mimicking the operation of the physical space of the industrial operations. Digital twins generally include asset twins and process twins which help the subject matter experts to monitor the operations and make any necessary changes to operating parameters to simulate one or more scenarios which otherwise is very cumbersome to implement in physical space of industrial operation. The digital twins also help in identifying anomaly based on operating parameters and validating the root cause. However, the digital twins of the industrial process are generally operated or accessed by subject matter experts or process engineers who have in-depth knowledge of process and asset parameters. Hence, running of anomaly scenarios and selecting mitigation strategy is effectively carried out by process engineers and may not be used by a non-expert.

Therefore, there are challenges with existing systems, which can be only accessed and used by skilled engineers and may not be accessed by a non-expert. Further, the existing system only reply upon the controlling inputs such as change in parameters which can be done only by skilled person and a non-expert may not be able to use the digital twins effectively using vocal or text commands and requires specialized skills.

There exists a need for providing a solution to the above drawbacks by providing the user/workforce/frontline workers with mechanisms which can help providing an interactive user interface that can be useful also to a non-skilled engineer.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure herein provide a system and a method for providing aid to the workforce in an industrial process. Other implementations will be, or will become, apparent to one with skill in the art upon examination of the following figures and detailed description. It is intended that all such additional implementations be included within this description be within the scope of the disclosure.

In an embodiment, the present disclosure provides a method for providing an interactive co-pilot in an industrial operation. The method comprises the steps of providing an interactive user interface (UI) wherein the user interface provides natural language processing capability for processing one or more user requests, accessing a real-time digital twin of one or more processes and associated assets with the one or more processes wherein the real-time digital twin includes an asset digital twin and a process digital twin, receiving the one or more user requests including at least one of execution of optimization scenarios, monitoring anomaly, and unplanned event detection. Further, the method comprises the steps of monitoring one or more asset parameters associated with assets from the asset digital twin, monitoring one or more process parameters associated with processes from the process digital twin and simulating, by a machine learning (ML) model, one or more scenarios corresponding to the user request to generate one or more outcomes, based on the one or more asset parameters and the one or more process parameters. The method also comprises presenting to a user, via the interactive user interface, the one or more outcomes corresponding to the user request for user selection.

In an embodiment, the method comprises processing the one or more user requests by applying natural language processing (NLP) technique.

In yet another embodiment, the method further comprises identifying, based on the one or more user requests for monitoring the anomaly, at least one process parameter deviation and at least one asset parameter deviation, predicting at least one anomaly in an event based on at least one of: the at least one asset parameter deviation and the at least one process parameter deviation. Further, the one or more scenarios are simulated to identify effect of the at least one anomaly based on at least one of: the at least one asset parameter deviation and the at least one process parameter deviation. Further, a plurality of mitigation strategies is determined for the at least one anomaly, wherein each strategy is associated with a confidence score and the plurality of mitigation strategies are presented to the user for the user's selection.

In yet another embodiment, the method comprises determining at least one root cause for the at least one anomaly based on at least one of: the at least one asset parameter deviation and the at least one process parameter deviation.

In another embodiment, the ML model is a surrogate model.

In yet another embodiment, the method comprises executing the surrogate model to generate one or more mitigation scenarios, based on an estimated time period for occurrence of the anomaly.

In yet another embodiment, the method comprises associating a weightage score to the plurality of mitigation strategies, wherein the weightage score is based on energy usage for implementing one or more mitigation strategies.

In yet another embodiment, the method comprises executing, based on the user selection, at least one mitigation strategy to rectify the at least one anomaly.

In another embodiment, the method further comprises simulating, based on the user request for execution of one or more optimization scenarios, the one or more scenarios in the real-time digital twin to determine optimization of the one or more processes, presenting, to the user, the one or more optimization scenarios for the user selection and executing at least one optimization scenario based on the user selection.

In yet another embodiment, the method comprises integrating the one or more optimization scenarios generated by the real-time digital twin with an advanced process control (APC) application of the industrial operation.

In another embodiment, the present disclosure provides a system for providing interactive co-pilot in an industrial operation. The system comprises one or more processors, a memory storing program instructions which, when executed by the one or more processor, causes the processor to: provide an interactive user interface (UI), wherein the user interface provides natural language processing capability for processing one or more user requests, access a real-time digital twin of one or more processes and associated assets with the one or more processes, wherein the real-time digital twin includes an asset digital twin and a process digital twin, receive the one or more user requests including at least one of execution of optimization scenarios, monitoring anomaly, and unplanned event detection, monitor one or more asset parameters associated with assets from the asset digital twin, monitor one or more process parameters associated with processes from the process digital twin, simulate, by a machine learning (ML) model, one or more scenarios corresponding to the user request to generate one or more outcomes, based on the one or more asset parameters and the one or more process parameters and present to a user, via the interactive user interface, the one or more outcomes corresponding to the user request for user selection.

In an embodiment, the processor is configured to process the one or more user requests by applying natural language processing (NLP) technique.

In yet another embodiment, the processor is configured to identify, based on the one or more user requests for monitoring the anomaly, at least one process parameter deviation and at least one asset parameter deviation, predict at least one anomaly in an event based on at least one of: the at least one asset parameter deviation and the at least one process parameter deviation, simulate the one or more scenarios to identify effect of the at least one anomaly based on at least one of: the at least one asset parameter deviation and the at least one process parameter deviation, determine a plurality of mitigation strategies for the at least one anomaly, wherein each strategy is associated with a confidence score and present, for the user selection, the plurality of mitigation strategies to the user.

In yet another embodiment, the processor is configured to determine at least one root cause for the at least one anomaly based on at least one of: the at least one asset parameter deviation and the at least one process parameter deviation.

In an embodiment, the ML model is a surrogate model and the processor is configured to execute the surrogate model to generate one or more mitigation scenarios, based on an estimated time period for occurrence of the anomaly.

In yet another embodiment, the processor is configured to associate a weightage score to the plurality of mitigation strategies, wherein the weightage score is based on energy usage for implementing one or more mitigation strategies.

In an embodiment, the processor is configured to simulate, based on the user request for execution of one or more optimization scenarios, the one or more scenarios in the real-time digital twin to determine optimization of the one or more processes, present, to the user, the one or more optimization scenarios for the user selection, and execute at least one optimization scenario based on the user selection.

In yet another embodiment, the processor is configured to integrate the one or more optimization scenarios generated by the real-time digital twin with an advanced process control (APC) application of the industrial operation.

In another embodiment, the present disclosure provides a non-transitory computer-readable storage medium storing program instructions for providing interactive co-pilot in an industrial operation, the instructions, when executed, perform the steps of providing an interactive user interface (UI), wherein the user interface provides natural language processing capability for processing one or more user requests, accessing a real-time digital twin of one or more processes and associated assets with the one or more processes, wherein the real-time digital twin includes an asset digital twin and a process digital twin, receiving one or more user requests including at least one of execution of optimization scenarios, monitoring anomaly, and unplanned event detection, monitoring one or more asset parameters associated with assets from the asset digital twin, monitoring one or more process parameters associated with processes from the process digital twin, simulating, by a machine learning (ML) model, one or more scenarios corresponding to the user request to generate one or more outcomes, based on the one or more asset parameters and the one or more process parameters, and presenting to a user, via the interactive user interface, one or more outcomes corresponding to the user request for user selection.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure.

FIG. 1 illustrates an exemplary architecture of digital twin in an industrial process;

FIG. 2 illustrates an exemplary digital twin architecture for an industrial process, in accordance with an embodiment of the present disclosure;

FIG. 3 illustrates an exemplary Interactive co-pilot with user interface UI coupled to digital twin, in accordance with an embodiment of the present disclosure;

FIG. 4 illustrates a natural language processing NLP module of the interactive co-pilot, in accordance with an embodiment of the present disclosure;

FIG. 5 illustrates a flow diagram of NLP based query processing with the digital twin, in accordance with an embodiment of the present disclosure;

FIG. 6 illustrates a block diagram providing confidence score and energy consumption score of scenario recommendations, in accordance with an embodiment of the present disclosure;

FIG. 7 illustrates a block diagram for integrating user selected recommendations with advance process control (APC) module, in accordance with embodiment of the present disclosure;

FIG. 8 illustrates an exemplary user interface (UI) of interactive co-pilot accessed by one or more users, in accordance with one embodiment of the present disclosure;

FIG. 9 illustrates a flowchart for utilizing interactive co-pilot, according to an embodiment of the present disclosure; and

FIG. 10 illustrates a flowchart for providing anomaly detection, according to an embodiment of the present disclosure; and

FIG. 11 illustrates general architecture of the system for implementation, in accordance with an embodiment of the present invention.

The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

### DETAILED DESCRIPTION OF THE INVENTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

In general, manufacturing units or plant facilities include numerous equipment/machines/devices, standard operating procedures for each equipment/device, operating parameters, equipment failure management, and maintenance heads who are responsible for monitoring and managing the smooth operation of the facility. There are numerous challenges like handling of equipment failure, production issues, functional issues, knowing how, technical support, time management, etc. In a plant facility, there are human resources including experts, equipment operators, and maintenance engineers who are involved in running and executing the equipment on day-to-day basis. However, any failure in the equipment, or underlying products needs to be resolved in a quick turn-around time to have minimum impact on overall functioning of the facility.

Whenever there is an issue with equipment/devices/products, the workforce at the facilities have to rely on their competency, approach the in-house expertise/support team to get resolutions/propositions with interim approaches. However, such measures may take longer time resolution of the issues and often affects the overall functioning of the equipment/plant.

Digital twins are commonly known which mimics the functioning of the plant facilities and maps the assets and processes associated with plant facilities. The digital twins are particularly advantageous in terms of its accessibility and quick identification of issues related to any assets and processes. For example, each asset and process may have their operating ranges including any threshold values and any deviation in their values may indicate potential anomaly and unplanned events which may results in equipment failure or process slowdown. Since, the plant facilities have numerous assets and processes, it is not feasible to have access to each asset for its monitoring purpose and in this respect, digital twin plays a very crucial role in providing a user or an operator who is assumingly a skilled person to continuously monitor parameters associated with each asset and process.

With advancement in technology, the digital twins also provide the advantage of executing multiple scenarios to find ways to optimize the existing functions of the plant facilities and the user or operator may implement one or more scenarios generated by a simulation model. Also, the digital twins enable the operator to constantly view the results of optimizations by way of execution of execution algorithms involving asset and process parameters.

One of the challenges in accessing the digital twin is that the operator must be a skilled person who has in-depth knowledge of technology and operating parameters of the processes. The operator, who is skilled and has technology know-how will be able to understand the digital twin and performs various controlling operations which can be integrated with advance process control of the plant facilities. When there is an issue with equipment/devices/products/assets, the workforce at the facilities must rely on their competency, approach the in-house expertise/support team to get resolutions/propositions with interim approaches. Also, the process variables and standard operating procedures of an equipment may vary from industry to industry.

In such scenario, the digital twins which fetches the real time operation of the plant facilities may not understood and operated by non-experts upon identification of an anomaly. Further, a non-expert may not be able to use the digital twin effectively to generate optimization scenarios and to present to the user various options for sections which can be easily understood by the operators.

There exists a need for providing a solution to the above drawbacks by providing the user with a system which can help providing an interactive user interface which can be useful also to a non-skilled engineer. The present invention provides a solution to the above drawbacks by providing a method and a system, by which the non-skilled workforce/frontline workers will be able to seek resolution to any issues through an interactive interface that could be deployed along with the other applications. Through this invention, the workforce/frontline workers will be able to seek guidance through the interactive interface and get quick resolution. Detailed operation of the system has been provided henceforth with reference to several figures.

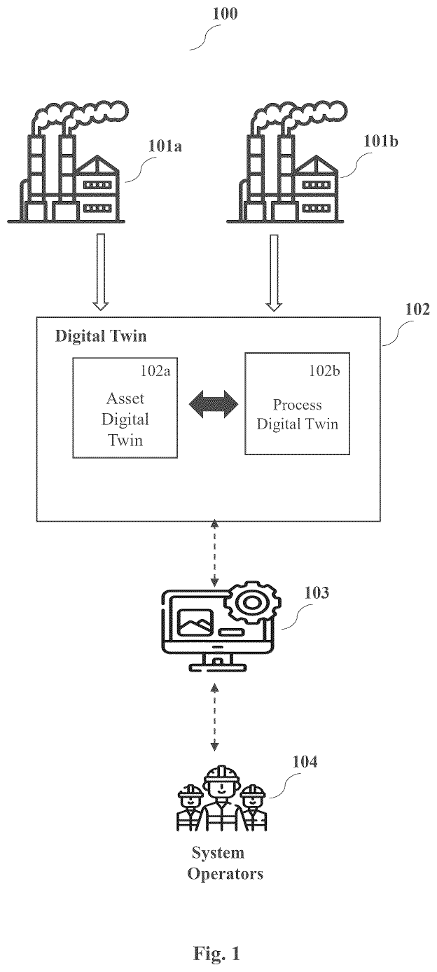

FIG. 1 illustrates an exemplary architecture of digital twin in an industrial process. The architecture 100 comprises one or more plant facilities 101a, 101b which are coupled to a digital twin 102. In an embodiment, the digital twin 102 comprises at least one asset digital twin 102a and at least one process digital twin 102b. The asset digital twin 102a mimics one or more assets of the one or more plant facilities 101a, 101b to provide the digital representation of the physical assets of the plant facilities 101a, 101b. For example, the digital twin of the twinned physical facilities provides details of sensors which sense values of designation parameters of the physical facilities. In an embodiment, the digital twin may include a processor (not shown) which receives data associated with the sensors, monitors the operation conditions of the selected sensors. A communication port may be provided which transmits such details of sensors to the processor and the processor subsequently may perform the monitoring/assessing, when there are deviations in sensor's operation.

Similarly, the process digital twin 102b of the digital twin 102 mimics one or more processes running with the plant facilities and also collects the operating conditions associated with the processes, and connected processes associated with the monitored process. Such process parameters are provided to the processor (not shown) for further processing, so that such parameters represented or displayed to users or operator 104 operating the digital twin 102. Further, the details also may include associated assets with each of the processors and interconnected assets so as to identify root cause of any potential failures in any asset or processes. In an embodiment, the asset digital twin 102a and the process digital twin 102b may be separately formed and may be interrelated using defined protocols. In an alternative embodiment, the asset digital twin 102a and the process digital twin 102b may be integrated to form the digital twin 102.

The system 100 may further comprise a user device 103 with an interface, on which the digital twin is represented along with the parameters values and associated deviations. The operator 104 may access the user interface 103 through user platforms to view details and to manage the digital twin by inputting one or more controlling parameters. In an example, the user interface 103 may allow the operator to define and/or adjust parameters and/or provide or receive generated recommendations or results. In an embodiment, the operator may select any particular assets or operations for continuous monitoring and, also may set thresholds for identify deviations.

In an embodiment, the digital twin is connected to the user device 103 via a network. The network may be a public network (e.g., the Internet), a private network (e.g., an internal localized, or closed-off network between particular devices). In some other embodiments, the network may be a hybrid network (e.g., a network enabling internal communications between particular connected devices and external communications with other devices). In various embodiments, the network may include one or more base station(s), relay(s), router(s), switch(es), routing station(s), and/or the like.

In an exemplary embodiment, the user device 103 may be a handheld device or a computer. The user device(s) 104 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein.

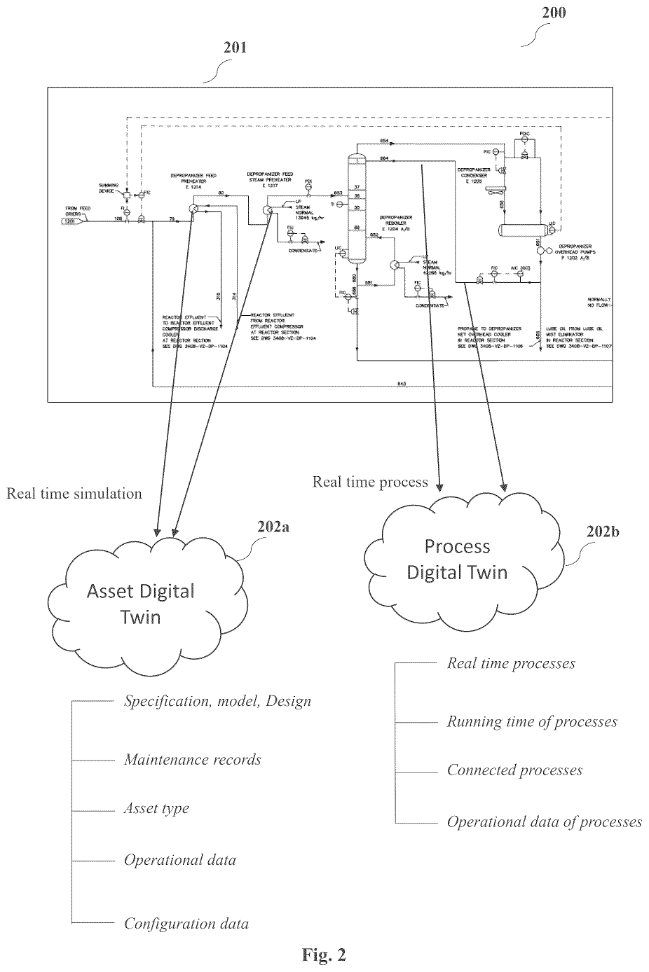

FIG. 2 illustrates an exemplary digital twin architecture 200 for an industrial process, in accordance with an embodiment of the present disclosure. An exemplary physical plant facility 201 is illustrated which represents an industrial set with a plurality of industry assets and processes between the plurality of the assets. An asset digital twin 202a is provided which mimics the operational parameters of the assets of the plant facility 201 and a process digital twin 202b is provided which mimics the operational parameters of the processes running in the plant facility 201. In an embodiment of the present invention, the asset digital twin 202a and the process digital twin 202b fetch the real-time operational parameters of the assets and processes of the plant facilities.

In an embodiment, the asset digital twin 202a and the process digital twin 202b receive continual updates from assets (may also be referred to as equipment) and outputs from platforms and running processes. In a preferred embodiment, the asset and process digital twin (202a, 202b) obtains real-time data/parameters from the physical plant facilities thereby providing the advantages of real time data acquisition and subsequent simulations, based data processing. The real-time digital twins (202a, 202b) track dynamic state information about an asset to help in streaming analysis.

In an embodiment, the real time data/parameters which may be obtained from the assets may include, but are not limited to, asset specification, model and design parameters, maintenance, service or replacement records, asset type, operational performance data for a specified period of time, accuracy data, configuration data. Similarly, the real time data/parameters associated with the processes may include, not limited to, the running time of each of the processes, interconnection between various processes, operations thresholds of process parameters etc.

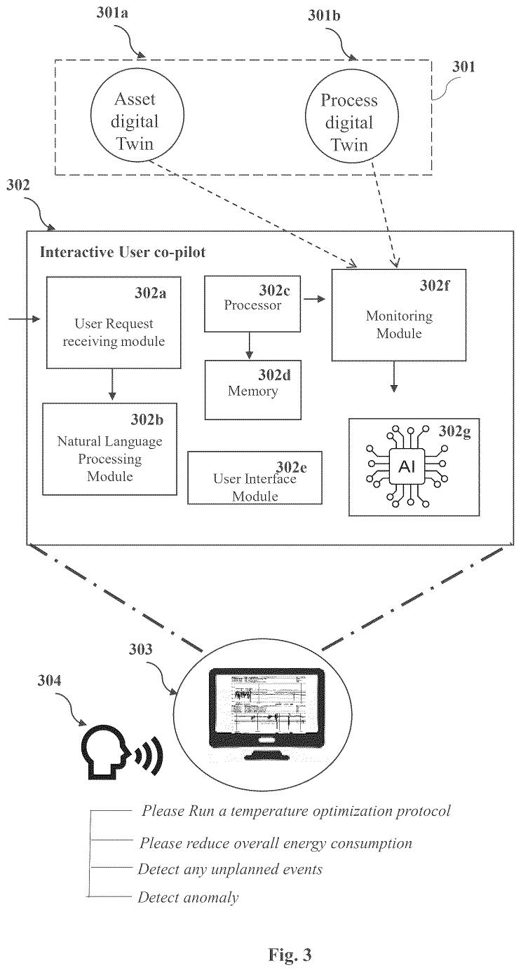

These real-time data are fetched and displayed on the user device for view and controlling by the operator. A more detailed embodiments of the user interface is illustrated in forthcoming explanations in reference to FIG. 3 to FIG. 5 and FIG. 7 to FIG. 8.

FIG. 3 illustrates an interactive co-pilot 302 coupled to digital twin 301, in accordance with an embodiment of the present disclosure. In an embodiment, a user or an operator 304 is configured to operate a device 303 to access and control the digital twin 301a, 301b and the device 303 is provided with the user interactive co-pilot 302 which is configured to receive user's request including at least one of text commands or vocal commands or both. The interactive co-pilot 302 comprises a user request receiving module 302a, a natural language processing module 302b, a processor 302c coupled to a memory 302d, a user interface module 302e, a monitoring module 302f, and a machine learning model 302g. The user interactive co-pilot 302 is coupled to the digital twin 301 comprising at least one asset digital twin 301a and at least one process digital twin 301b. In an embodiment, the user interactive co-pilot 302 is implemented in the user device 303 as an executable application or software. In another embodiment, the user interactive pilot 302 may be implemented as an application installed in the local server or as an on-demand application stored in cloud applications.

To begin with, the user 304 may send one or more commands to the Interactive user co-pilot 302 (hereinafter referred to as co-pilot) to perform one or more functions with the digital twin. In an embodiment, the functions may include, but are not limited to, execution of optimization scenarios, monitoring anomaly, and unplanned event detection. The user command may include, for example “Please run a temperature optimization protocol”, “please reduce overall energy consumption”, “detect any unplanned events”, or “detect any anomaly based on asset/process parameters” etc.

The user 304 may send his commands or request either by way of text input or a vocal command. The user request receiving module 302a receives the user's command. In an embodiment, the co-pilot 302 may receive user's command based on his authorization to access the co-pilot. The memory 302d may store user's profile and may authorize the user's access by at least one of user's code, unique passcode, voice detection, biometric authorization or any other mechanisms known to a person skilled in the art. Based on access request by any user for accessing user device, the processor 302c may process the user's request by authenticating the credential entered by the user. In an embodiment, the processor 302c may access user's profile and its credential stored in the memory 302d.

The receiving module 302a receives the user command either though the text entered in a Chat-box or through a mic associated with the co-pilot 302. The user requests are forwarded to the Natural Language Processing (NLP) module 302b for processing the user's request. The NLP module 302b processes the user requests to identify the semantic meaning of the user's command entered via either chat-box or vocal command and derive the meaning of the user's command. The NLP module 302b is coupled to the processor 302c, wherein the processor 302c receives the semantic meaning of the user's command and generates one or more control commands. One or more control commands are subsequently forwarded to the monitoring module 302f for accessing the digital twin for monitoring the parameter associated with the assets and processes.

In an embodiment, one or more selected assets and selected processes are identified based on the user's command. The processor 302c based on processing by NLP module 302b, identifies specific assets and processes which are intended to be monitored. Accordingly, one or more control commands associated with the intended assets and processes are generated and forwarded to the monitoring module 302f for accessing the digital twin for monitoring the parameters associated with the selected assets and processes. In a further embodiment, one or more control commands generated by the processor 302c may include the intention of the user's request and include but are not limited to, execution of optimization scenarios, monitoring anomaly, and unplanned event detection.

Once, one or more control commands are received, the monitoring module 302f is activated to monitor parameters associated with the assets and processes. In an embodiment, the monitoring module 302f is configured to monitor, in real time, asset specification, model and design parameters, maintenance, service or replacement records, asset type, operational performance data for a specified period of time, accuracy data, configuration data. Similarly, the monitoring module 302f is configured to monitor, in real time, parameters associated with the processes for example, running time of each of the processes, interconnection between various processes, operations thresholds of process parameters etc.

The monitoring module 302f receives the parameters from the digital twin having asset digital twin 301a and process digital twin 301b and the received parameters are forwarded to the Machine Learning (ML) model 302g for execution one or more simulations. In an embodiment, where the user command includes a request for executing optimization scenarios, the ML model 302g executes one or more simulations to generate optimization scenarios which may increase the productivity of selected assets or processes. In an embodiment, the ML model may be a Discrete Event Simulation (DES) model, which may correlate real-time data to identify possible one or more optimal scenarios. The one or more optimal scenarios may include, in an example, improving processing time, asset performance etc.

In another embodiment, the ML model 302g executes anomaly detection in the running processes and associated assets. In an example, for a plant facility with multiple sensors, the sensor information is continuously compared with threshold values for identification of a first anomaly (also referred to as a hardware related anomaly). Specifically, higher and lower limits of values of the sensor information coming from each sensor may be predefined by the user based on an expected operation of the sensors and their past performances i.e. using historical data of the sensors. The sensor information is compared with respective predefined limits to determine whether the sensor information is present above or below the respective predefined limits.

In an industrial set up or plant facilities, they may include, but are not limited to, barcode scanner malfunctions, RFID reader problems, label printer failures, wired or wireless network issues, forklift sensor failures, conveyor belt breakdowns, pallet racking damage, Automated Guided Vehicle (AGV) problems, voice-picking system issues, Warehouse Management System (WMS) hardware failures, climate control system breakdowns, dock door malfunctions, security system failures, handheld device problems, automated sorting system breakdowns, power supply interruptions, pick-to-light system issues, dust and debris accumulation, and battery failures in equipment.

A violation of the predefined limits may indicate the hardware related anomaly in an event performed by an asset. Details of the hardware related anomaly may be stored in the memory for future reference. Further, the operator 304 may be notified about the hardware related anomaly so that an appropriate action is taken.

In another embodiment, the ML model 302g may execute scenarios associated with unplanned events and provide one or more recommendations to the user for mitigation. The ML model 302g may provide recommendations, wherein recommendations may be based on identified bottleneck scenario.

Once the ML Model 302g executes at least one of commands associated with optimization scenarios, monitoring anomaly, and unplanned event detection, one or more optimization scenarios or mitigation scenarios are displayed on the user device through the user interface module 302e. In an embodiment, each of the optimization scenarios or mitigation scenarios may be associated with a confidence score for ranking the recommendations for user selection and execution.

In an embodiment, the ML model 302g is a surrogate model. The surrogate models represent simplified models which may mimic the behaviour of simulation models and provide nearly similar results in less time. Particularly, when the detected anomaly is of critical nature with an estimated time period for occurrence, and mandates quick turnaround time for determining mitigation strategies with a comparatively large number of parameters being retrieved from plant facilities associated with assets and processes, the surrogate models may be executed which may prove efficiency in providing scenarios/mitigation strategies faster than conventional simulation models.

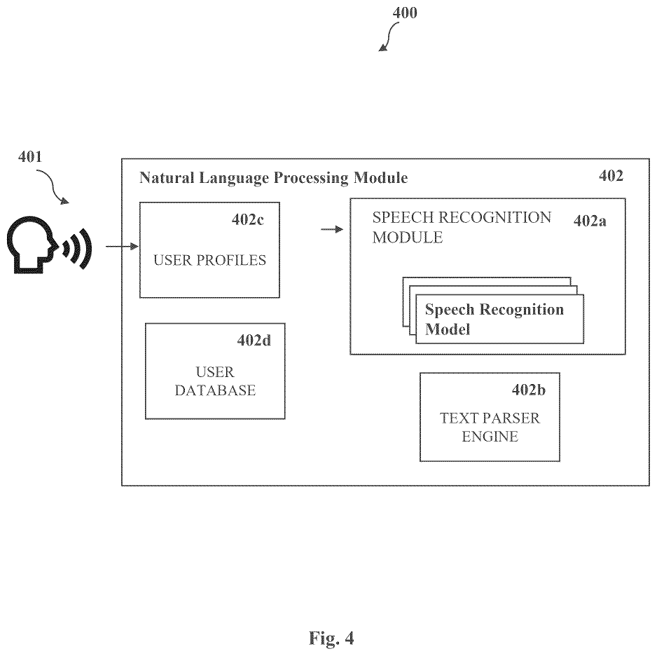

FIG. 4 illustrates an exemplary natural language processing NLP module 402 of the interactive UI, in accordance with an embodiment of the present disclosure. In an embodiment, when user 401 sends one or more commands to the co-pilot to perform one or more functions with the digital twin, the user command is forwarded to the NLP module 402. The NLP module 402 process the user requests to identify the semantic meaning of the user's command entered via either a chat-box or a vocal command and derive the meaning of the user's command.

In an embodiment, the NLP module 402 may comprises a speech recognition module 402a, a text parser engine 402b. In an embodiment, the speech recognition module 402a includes a speech recognition model for determining text and/or other semantic representations of a spoken utterance embodied in vocal command. In an embodiment, a plurality of speech recognition models may be provided for different languages (for example, English, French, Spanish, Mandarin, Japanese), etc. In an embodiment, a language model can refer to an acoustic model, a speech recognition model, an invocation phrase model, a voice-to-text model, a voice-to-semantic representation model, a text-to-semantic representation model, which may be utilized for translating a natural language input into data which may be processed by a device. In a further embodiment, the text parser engine 402b may process a text input into semantic data that may be used to generate control command for the monitoring module.

Further, the NLP module 402 may comprises a user profile module 402c and user database 402d. In an embodiment, the user profile module 402c may provide access to user to access NLP based on at least one of user's code, unique passcode, voice detection, biometric authorization. Further, the user database 402d may store user's profiles who are authorized to access the NLP module based on their hierarchy level and may be updated from time to time.

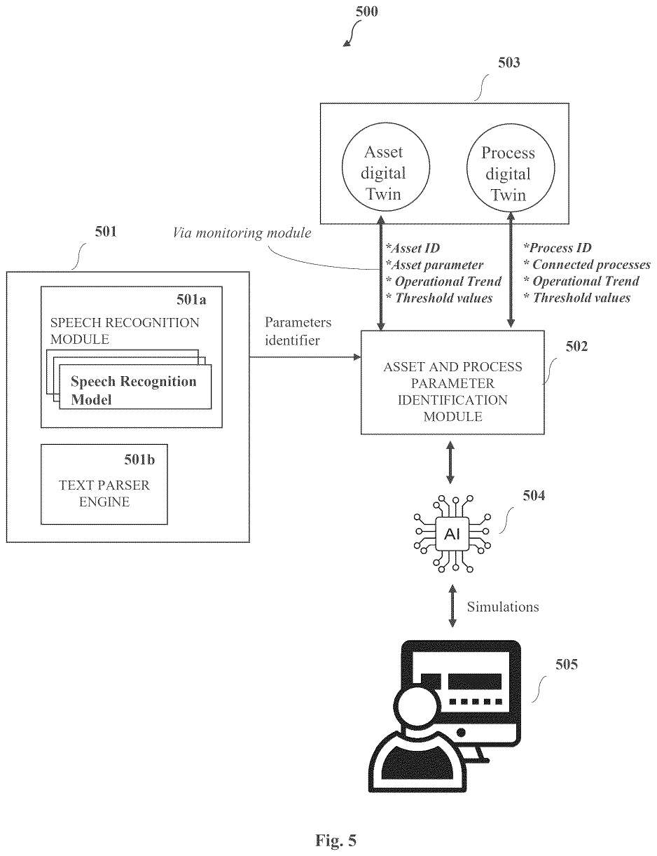

FIG. 5 illustrates a flow diagram of NLP based query processing with the digital twin, in accordance with an embodiment of the present disclosure.

In an embodiment, an asset and process parameter identification module 502 may be provided coupled to a speech recognition module 501a. As explained above, the speech recognition module 501a includes a speech recognition model for determining text and/or other semantic representations of a spoken utterance embodied in the vocal command. Based on the user's request, the speech recognition module 501a derives the semantic meaning of the user requests, and for the monitoring module to monitor parameters from the digital twins, the asset and process parameter identification module 502 derives the asset and processes parameters from semantic representations of the vocal command given by the user. In an embodiment, one or more asset parameters for example, asset ID, asset parameter, operational trend, and threshold values associated with the asset may be derived from the semantic meaning of the user requests. Similarly, in an embodiment, one or more process parameters, for example, process ID, connected processes, operational trend of the processes, and threshold values may be derived from the semantic meaning of the user requests.

Based on the asset and process parameters derived from the semantic meaning of the user requests, the digital twin is accessed to fetch required information/metrics based on asset and process parameters. Subsequently, a ML model 504 is executed to run simulations to generate scenarios, and mitigation strategies, and the generated results are displayed to the user via user device 505.

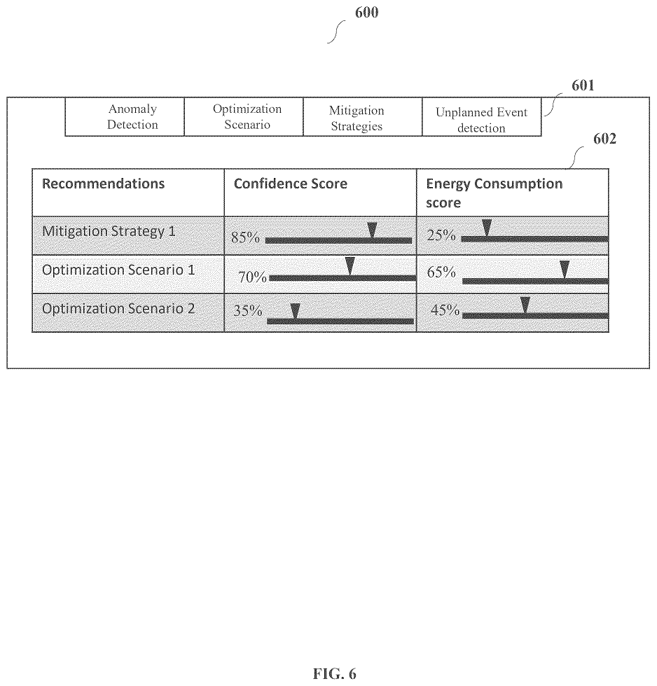

FIG. 6 illustrates a block diagram providing confidence score and energy consumption score of scenario recommendations, in accordance with an embodiment of the present disclosure.

As described above, the ML model is executed to run simulations to generate scenarios, and mitigation strategies and the generated results are displayed to the user via the user device. The output of the ML model provides one or more recommendations on mitigation strategies, and the plurality of optimization scenarios, along with the confidence score and energy consumption score. In an example, the confidence score indicates the success rate of implementation of one or more optimization scenarios or mitigation strategies. Further, in an additional embodiment, the energy consumption score may be provided along with the confidence score.

For example, in an industrial plant set up, the user requests include finding optimization scenarios to reduce time for process 1. Based on processing of the user requests, the ML model will generate multiple optimization scenarios along with the confidence score and the energy consumption score. In an embodiment, while for an optimization scenario 1, the confidence score may be high and the energy consumption may also be high. For an optimization scenario 2, the confidence score may be average but the energy consumption may be low. Based on the user preference and given that both the confidence score and the energy consumption score are displayed to user selection, the user may prefer selecting the optimization scenario which has low energy consumption score, if there are limitations on energy consumption.

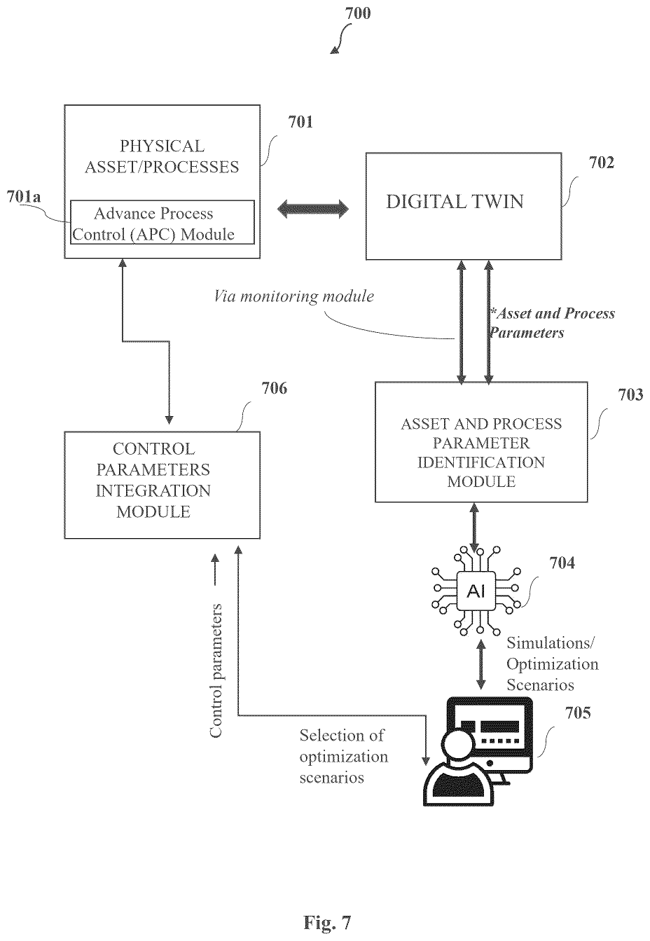

FIG. 7 illustrates a block diagram 700 for integrating user selected recommendations with advance process control (APC) module, in accordance with embodiment of the present disclosure.

Based on the user's selection on one or more optimization scenarios or mitigation strategies based on confidence score and/or energy consumption score, control parameters associated with optimization scenarios or mitigation strategies are sent to an advanced process control (APC) module 701a of the physical plant facilities 701. In an embodiment, the interactive co-pilot 705 may provide a control parameters integration module 706 which receives the user selection of one or more optimization scenarios or mitigation strategies and the control parameters integration module 706 sends integration signals to the advanced process control (APC) module 701a of the physical plant facilities, to implement the selected optimization scenarios or mitigation strategies.

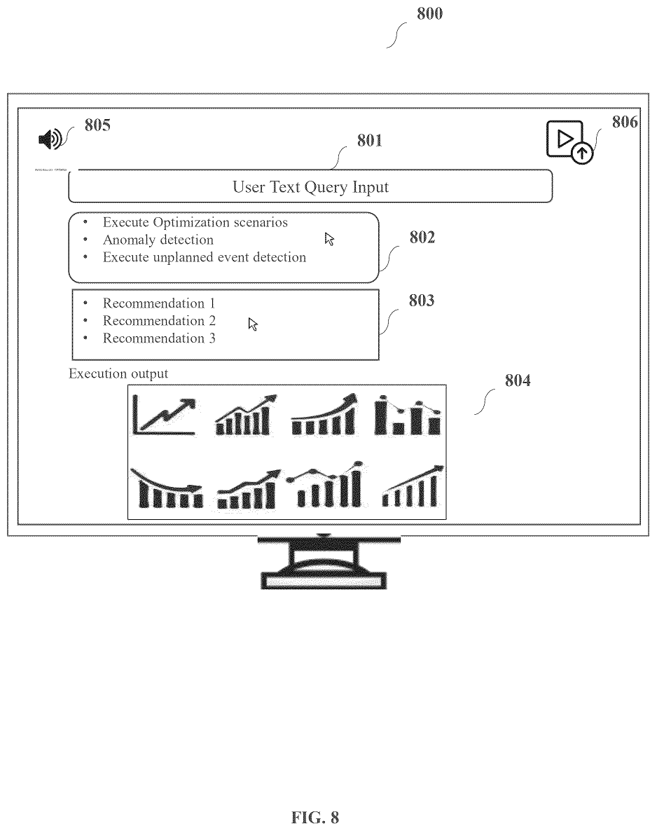

FIG. 8 illustrates an exemplary user interface (UI) 800 of industrial co-pilot accessed by one or more users, in accordance with one embodiment of the present disclosure.

The user interface 800 comprises an input box 801, where the user who are responsible for monitoring and operating the asset/process, can enter their request or query regarding the issue encountered in operations of the equipment or to monitor the anomaly or to executed optimization scenarios. In an embodiment, the user may enter their text query and submit it. In alternative embodiment, the user may have option to submit input by way of vocal commands 805 through a mic option. In an alternative embodiment, the user may upload a document via option 806 which contains the user's queries or requests.

Once the user submits their query, the display portion 802 may contain one or more options which provide a manual way of selecting one of options from optimization scenarios, anomaly detection, and unplanned event detection. Once the ML model executes simulations or optimization scenarios, the display portion 803 displays one or more recommendations or optimization scenarios for use selection. In an embodiment, the user interface may include display portion 804 which shows parameters associated with assets and processes and displays KPI's associated with processes for user's monitoring.

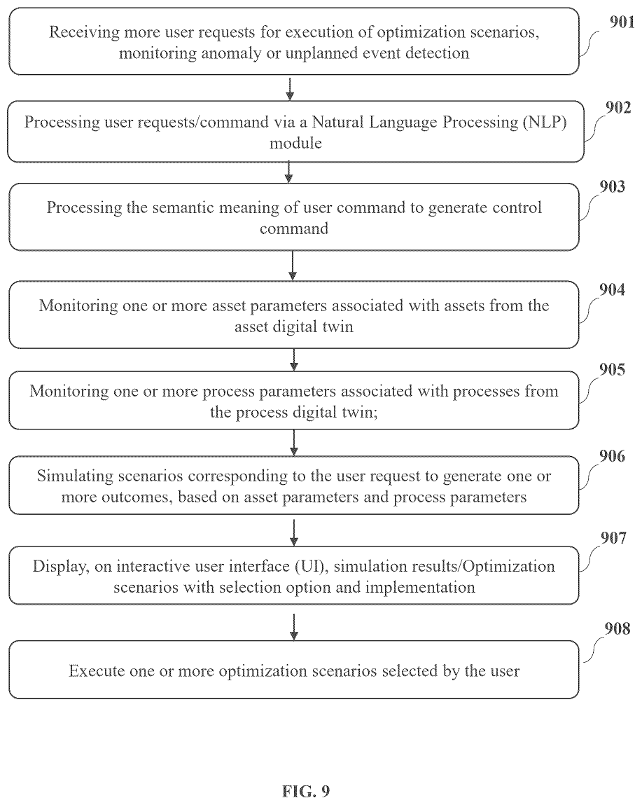

FIG. 9 illustrates a flowchart for utilizing interactive co-pilot, according to an embodiment of the present disclosure.

In Step 901, the user 304 may send one or more commands to the co-pilot 302 of the user device 303 to perform one or more functions with the digital twin. The functions may include, but are not limited to, execution of optimization scenarios, monitoring anomaly, and unplanned event detection. The user command may include, for example, “Please run a temperature optimization protocol”, “please reduce overall energy consumption”, “detect any unplanned events”, or “detect any anomaly based on asset/process parameters” etc.

In an embodiment, the user 304 may send his commands or request either by way of text input or a vocal command. As illustrated in FIG. 3, the user request receiving module 302a receives the user's command. In an embodiment, the user device may receive user's command based on his authorization to access the user device. The memory 302d may store user's profile and may authorize the user's access by at least one of user's code, unique passcode, voice detection, biometric authorization or any other mechanisms known to a person skilled in the art. The receiving module 302a receives the user command either through the text entered in a Chat-box or through a mic associated with the user device 303.

In Step 902, the user requests are forwarded to the Natural Language Processing (NLP) module 302b for processing the user's request. The NLP module 302b process the user requests to identify the semantic meaning of the user's command entered via either chat-box or vocal command and derive the meaning of the user's command. The NLP module 302b is coupled to the processor 302c

In Step 903, the processor 302c receives the semantic meaning of the user's command and generate one or more control command. One or more control command is subsequently forwarded to the monitoring module 302f for accessing the digital twin for monitoring the parameter associated with the assets and processes. In an embodiment, one or more selected assets and selected processes are identified based on user's command. The processor 302c based on processing by NLP module 302b, identifies specific assets and processes which are intended to be monitored. Accordingly, one or more control commands associated with the intended assets and processes are generated and forwarded to the monitoring module 302f for accessing digital twin for monitoring the parameters associated with the selected assets and processes. In a further embodiment, one or more control commands generated by the processor 302c may include intention of user's request and include, but limited to, execution of optimization scenarios, monitoring anomaly, and unplanned event detection.

In Step 904, once one or more control commands are received, the monitoring module 302f is activated to monitor parameters associated with the assets and processes. In an embodiment, the monitoring module 302f is configured to monitor, in real time, asset specification, model and design parameters, maintenance, service or replacement records, asset type, operational performance data for a specified period of time, accuracy data, configuration data.

In Step 905, the monitoring module 302f is configured to monitor, in real time, parameters associated with the processes for example, running time of each of the processes, interconnection between various processes, operations thresholds of process parameters etc.

In Step 906, the monitoring module 302f receives the parameters from the digital twin having asset digital twin 301a and process digital twin 301b and the received parameters are forwarded to the Machine Learning (ML) model 302g for execution one or more simulation. In an embodiment, where the user command include request for executing optimization scenarios, the ML model 302g executes one or more simulations to generate optimization scenarios which may increase the productivity of selected assets or processes. In an embodiment, the ML model may be a Discrete Event Simulation (DES) model, which may correlate real-time data to identify possible one or more optimal scenarios. The one or more optimal scenarios may include, in an example, improving processing time, asset performance, etc. In another embodiment, ML model 302g executes anomaly detection in the running processes and associated assets. In an example, for a plant facility with multiple sensors, the sensor information is continuously compared with threshold values for identification of a first anomaly (also referred to as a hardware related anomaly). Specifically, higher and lower limits of values of the sensor information coming from each sensor may be predefined by the user based on an expected operation of the sensors and their past performances i.e. using historical data of the sensors. The sensor information is compared with respective predefined limits to determine whether the sensor information is present above or below the respective predefined limits. A violation of the predefined limits may indicate the hardware related anomaly in an event performed by an asset. Details of the hardware related anomaly may be stored in the memory for future reference. Further, the operator 304 may be notified about the hardware related anomaly so that an appropriate action is taken. In another embodiment, the ML model 302g may execute scenarios associated with unplanned events and provide one or more recommendations to the user for mitigation. The ML model 302g may provide recommendations, wherein recommendations may be based on the identified bottleneck scenario.

In Step 907, once the ML Model 302g executed at least one of commands associated with optimization scenarios, monitoring anomaly, and unplanned event detection, one or more optimization scenarios or mitigation scenarios is displayed on the user device through the user interface module 302e.

In Step 908, the user is provided with optimization scenarios or mitigation scenarios along with confidence score for user selection and execution.

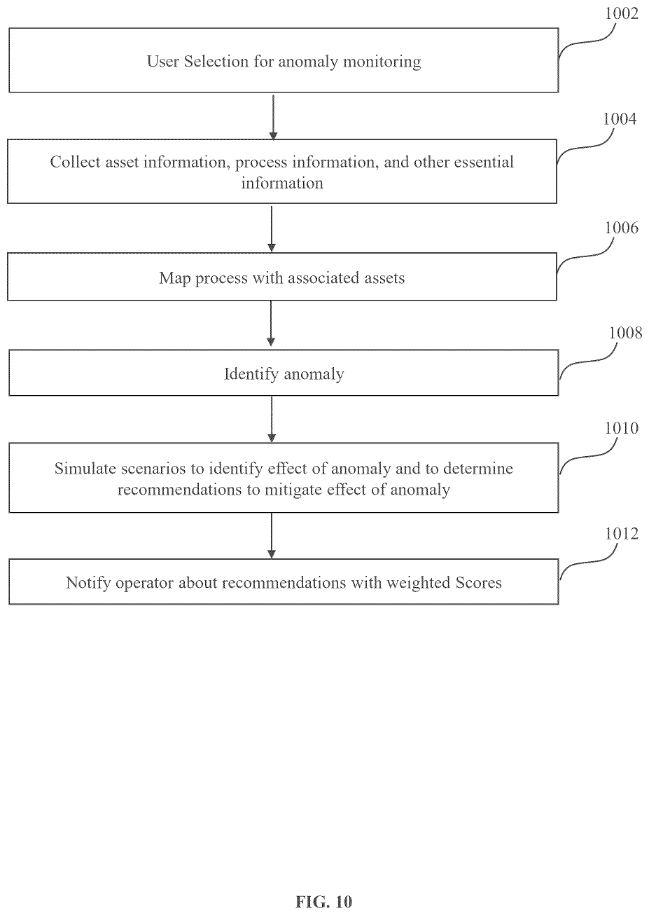

FIG. 10 illustrates a flowchart for providing anomaly detection in an exemplary embodiment, according to an embodiment of the present disclosure.

In Step 1002, the user may select for monitoring anomaly on interactive co-pilot, in functioning for asset and process in a plant facility.

In Step 1004, sensor information, workforce information, and other essential information, such as KPI metrices may be obtained. The sensor information may be received from sensors installed at different locations in the plant facilities. The sensor information may be related to events occurring within the plant facilities in a real-time.

In Step 1006, the sensor information may be mapped with assets present in the plant facilities. The sensor information may be mapped with the assets using a process model. The process model may include details of components, their connections, and their roles in performing different operations.

In Step 1008, an anomaly may be identified. The anomaly may be a hardware related anomaly or process related anomaly. The hardware related anomaly may be determined based on violation of predefined limits set or deviations for the sensor information related to the event. The process related anomaly is associated with failure to meet process protocols like delay in processing etc or process parameters deviations in handling an event.

In Step 1010, scenarios may be simulated to identify effect of the anomaly and to determine recommendations to mitigate effect of the anomaly. The scenarios may be simulated for example, based on the sensor information.

In Step 1012, the user or operator may be notified of the recommendations. In one case, the recommendations may include instructions for taking one more action for fixing the hardware related and process related anomaly.

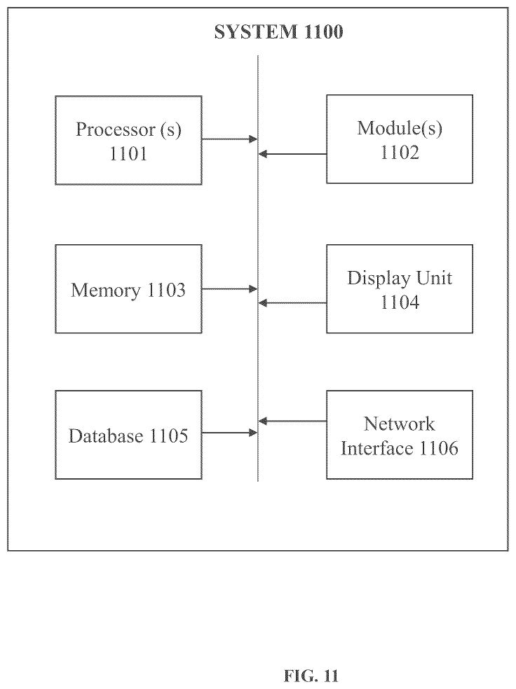

FIG. 11 illustrates a general block diagram of the system, according to an embodiment of the present disclosure.

In an example, the processor(s) 1101 may be a single processing unit or a number of units, all of which could include multiple computing units. The processor(s) 1101 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 1101 is configured to fetch and execute computer-readable instructions and data stored in a memory 1103.

The memory 1103 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 1102 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 1503 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 1102 when executed by the processor(s) 1101 may be configured to perform any of the described functionalities. According to an embodiment, the module 1102 includes one or more modules discussed above with reference to FIG. 3 to FIG. 5 and FIG. 7. In an alternate embodiment, the functions of the aforesaid modules may be performed by the processor(s) 1101.

As a further example, the database 1105 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processors(s) 1101, and the modules/engines/units.

The modules/engines/units 1102 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to decide or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

In an embodiment, one or more display unit 1104 may include a computer monitor, a touch screen, an output device capable of displaying the graphics, and the like. The display unit 1104 is configured to display visual output in desktops, laptops, and workstations. The display unit 1104 may come in different sizes, resolutions, and types (such as LCD, LED, or OLED).

As a further example, one or more network interface 1106 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

A processor may include one or more general purpose processors (e.g., INTEL® or Advanced Micro Devices® (AMD) microprocessors) and/or one or more special purpose processors (e.g., digital signal processors or Xilinx® System on Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms user, operator, person, employee, worker, labor, personnel, workforce, supervisor, and manager may have been used interchangeably throughout the draft and corresponds to an individual working in an industry or directly or indirectly managing operations in the industrial environment.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

What is claimed is:

1. A method for providing interactive co-pilot in an industrial operation, comprising:
providing an interactive user interface (UI), wherein the user interface provides natural language processing capability for processing one or more user requests;
accessing a real-time digital twin of one or more processes and associated assets with the one or more processes, wherein the real-time digital twin includes an asset digital twin and a process digital twin;
receiving the one or more user requests including at least one of execution of optimization scenarios, monitoring anomaly, and unplanned event detection;
monitoring one or more asset parameters associated with assets from the asset digital twin;
monitoring one or more process parameters associated with processes from the process digital twin;
simulating, by a machine learning (ML) model, one or more scenarios corresponding to the one or more user requests to generate one or more outcomes, based on the one or more asset parameters and the one or more process parameters; and
presenting to a user, via the interactive user interface, the one or more outcomes corresponding to the user request for user selection.

2. The method of claim 1, comprising:
processing the one or more user requests by applying natural language processing (NLP) technique.

3. The method of claim 1, comprising:
identifying, based on the one or more user requests for monitoring the anomaly, at least one process parameter deviation and at least one asset parameter deviation;
predicting at least one anomaly in an event based on at least one of: the at least one asset parameter deviation and the at least one process parameter deviation;
simulating the one or more scenarios to identify effect of the at least one anomaly based on at least one of: the at least one asset parameter deviation and the at least one process parameter deviation;
determining a plurality of mitigation strategies for the at least one anomaly, wherein each strategy is associated with a confidence score; and
presenting, for the user selection, the plurality of mitigation strategies to the user.

4. The method of claim 3, further comprising:
determining at least one root cause for the at least one anomaly based on at least one of: the at least one asset parameter deviation and the at least one process parameter deviation.

5. The method of claim 1, wherein the ML model is a surrogate model.

6. The method of claim 5, further comprising:
executing the surrogate model to generate one or more mitigation scenarios, based on an estimated time period for occurrence of the anomaly.

7. The method of claim 3, further comprising:
associating a weightage score to the plurality of mitigation strategies, wherein the weightage score is based on energy usage for implementing one or more mitigation strategies.

8. The method of claim 3, further comprising:
executing, based on the user selection, at least one mitigation strategy to rectify the at least one anomaly.

9. The method of claim 1, further comprising:
simulating, based on the user request for execution of one or more optimization scenarios, the one or more scenarios in the real-time digital twin to determine optimization of the one or more processes;
presenting, to the user, the one or more optimization scenarios for the user selection; and
executing at least one optimization scenario based on the user selection.

10. The method of claim 9, further comprising:
integrating the one or more optimization scenarios generated by the real-time digital twin with an advance process control (APC) of the industrial operation.

11. A system for providing interactive co-pilot in an industrial operation, comprising:
one or more processors;
a memory storing program instructions which, when executed by the one or more processor, causes the processor to:
provide an interactive user interface (UI), wherein the user interface provides natural language processing capability for processing one or more user requests;
access a real-time digital twin of one or more processes and associated assets with the one or more processes, wherein the real-time digital twin includes an asset digital twin and a process digital twin;
receive the one or more user requests including at least one of execution of optimization scenarios, monitoring anomaly, and unplanned event detection;
monitor one or more asset parameters associated with assets from the asset digital twin;
monitor one or more process parameters associated with processes from the process digital twin;
simulate, by a machine learning (ML) model, one or more scenarios corresponding to the one or more user requests to generate one or more outcomes, based on the one or more asset parameters and the one or more process parameters; and
present to a user, via the interactive user interface, the one or more outcomes corresponding to the user request for user selection.

12. The system of claim 11, wherein the one or more processors are configured to:
process the one or more user requests by applying natural language processing (NLP) technique.

13. The system of claim 11, wherein the one or more processors are configured to:
identify, based on the one or more user requests for monitoring the anomaly, at least one process parameter deviation and at least one asset parameter deviation;
predict at least one anomaly in an event based on at least one of: the at least one asset parameter deviation and the at least one process parameter deviation;
simulate the one or more scenarios to identify effect of the at least one anomaly based on at least one of: the at least one asset parameter deviation and the at least one process parameter deviation;
determine a plurality of mitigation strategies for the at least one anomaly, wherein each strategy is associated with a confidence score; and
present, for the user selection, the plurality of mitigation strategies to the user.

14. The system of claim 13, wherein the one or more processors are further configured to:
determine at least one root cause for the at least one anomaly based on at least one of: the at least one asset parameter deviation and the at least one process parameter deviation.

15. The system of claim 11, wherein the ML model is a surrogate model.

16. The system of claim 15, wherein the one or more processors are further configured to:
execute the surrogate model to generate one or more mitigation scenarios, based on an estimated time period for occurrence of the anomaly.

17. The system of claim 13, wherein the one or more processors are configured to:
associate a weightage score to the plurality of mitigation strategies, wherein the weightage score is based on energy usage for implementing one or more mitigation strategies.

18. The system of claim 11, wherein the one or more processors are configured to:
simulate, based on the one or more user requests for execution of one or more optimization scenarios, the one or more scenarios in the real-time digital twin to determine optimization of the one or more processes;
present, to the user, the one or more optimization scenarios for the user selection; and
execute at least one optimization scenario based on the user selection.

19. The system of claim 18, wherein the one or more processors are further configured to:
integrate the one or more optimization scenarios generated by the real-time digital twin with an advanced process control (APC) application of the industrial operation.

20. A non-transitory computer-readable storage medium storing program instructions for providing interactive co-pilot in an industrial operation, the instructions, when executed, perform the steps of:
providing an interactive user interface (UI), wherein the user interface provides natural language processing capability for processing one or more user requests;
accessing a real-time digital twin of one or more processes and associated assets with the one or more processes, wherein the real-time digital twin includes an asset digital twin and a process digital twin;
receiving one or more user requests including at least one of execution of optimization scenarios, monitoring anomaly, and unplanned event detection;
monitoring one or more asset parameters associated with assets from the asset digital twin;
monitoring one or more process parameters associated with processes from the process digital twin;
simulating, by a machine learning (ML) model, one or more scenarios corresponding to the user request to generate one or more outcomes, based on the one or more asset parameters and the one or more process parameters; and
presenting to a user, via the interactive user interface, the one or more outcomes corresponding to the user request for user selection.
